(19) United States
(12) Patent Application Publication
(10) Pub. No.: US 2011/0054851 A1
(43) Pub. Date: Mar. 3, 2011

(54) METHOD FOR DETECTING INFORMATION RELEVANT FOR THE CHARACTERIZATION OF JOINT MOVEMENTS

(76) Inventors: Markus Heller, Berlin (DE); William Taylor, Berlin (DE); Georg Duda, Berlin (DE); Rainald Ehrig, Berlin (DE)

(21) Appl. No.: 12/452,518

(22) PCT Filed: Jul. 4, 2008
(86) PCT No.: PCT/EP2008/058729

§ 371 Date: Apr. 16, 2010

(30) Foreign Application Priority Data
Jul. 6, 2007 (DE) 10 2007 031 946.2
Nov. 23, 2007 (DE) 10 2007 057 012.2

(51) Int. Cl. G06F 17/11; G06G 7/60

(52) U.S. Cl. 703/2

(57) ABSTRACT

The present invention concerns a method of detecting information relevant to the characterization of joint movements, wherein markers fitted on both sides of a body joint are used for the analysis of joint movements and wherein the method includes: determining a mean marker configuration and determining time-dependent discrepancies from the mean configuration, wherein an orthogonal distance regression is carried out for determining a mean marker configuration and wherein markers fitted on a respective side of the body joint are used; carrying out a weighted orthogonal distance regression using the time-dependent discrepancies from the mean configuration for weighting, wherein markers fitted on a respective side of the body joint are used; and solving a linear equalization problem using items of information which were determined by carrying out the weighted orthogonal distance regression.

### CROSS REFERENCE TO RELATED APPLICATIONS

This application is the U.S. National Stage of International Application Number PCT/EP2008/058729 filed on Jul. 4, 2008 which was published on Jan. 15, 2009 under International Publication Number WO 2009/007332.

### BACKGROUND OF THE INVENTION

1. Technical Field

The invention concerns determining information relevant to the characterization of joint movements. In particular the invention is concerned with the analysis of joint movements based on time-dependent and/or movement-dependent measurement of markers fitted on or in the body segments involved. In that respect the present invention allows quantification of skin marker displacements and the determination of skin elasticity when the markers used are skin markers. The invention is further concerned with determining joint parameters (for example body joint centers and axes) and detecting the accuracy of the joint parameters which are determined. In addition the invention makes it possible to detect items of information which relate generally to movements of bone fragments or parts which are in movable relationship with each other such as for example bone fragments of a fracture or bone breakage. The term of a joint thus involves a wide significance.

2. Discussion of Related Art

In movement analysis procedures, determining functional deficits in relation to movements, the diagnosis of diseases and injuries of the movements apparatus (for example osteoarthrosis, cruciate ligament injury), planning, implementation and monitoring of surgical interventions, monitoring of therapy success, in the prevention and rehabilitation of diseases and injuries to the movement apparatus, and in the development of ortheses or endoprostheses, there is often a need for precise analysis, characterization and determination of movements of joints (for example a knee or a hip). The movement of a skeleton can be measured with a plurality of methods such as for example percutaneous tracking markers in combination with videofluroscopy and bone pins. Those methods however are severely limited by virtue of their invasive character.

Measurements of markers which are fixed to the skin can provide information for predetermined body segments and are also used in determining the in vivo joint kinematics. If reflective markers are used, that involves non-invasive determination of the movement of predetermined body segments generally by means of direct measurement of positions of those reflective markers with infrared optical measurement systems during a given period of time. It is possible to derive from the data obtained by means of a non-invasive method, various items of information which are relevant to movement analysis procedures such as for example joint axes or joint pivots. It will be noted however that the previous methods suffer from the disadvantage that they are too inaccurate. During the measurement of marker positions, a relative movement occurs between the markers and the bones to be investigated. The errors which occur with such non-invasive measurement procedures generally have their origin in such movements of the markers, which are to be attributed to skin elasticity and slight tissue deformation or irregularities. To improve the accuracy of those methods, manual and time-consuming correction procedures often have to be carried out.

The aim of invasive or non-invasive methods is to determine for a respective body joint, for example a knee joint or a hip joint, one or more joint parameters which are possibly dependent on the position of the body segments (for example time-dependent), such as joint axes or one or more pivot points. Previous methods which permit that however have the common problem that a segment has to be transformed into the coordinate system of another segment to permit the use of a common coordinate system. With that transformation however, all measurement errors which have occurred in respect of a segment are also transformed into the coordinate system of the other segment; that is a further reason for the inaccuracy and thus unreliability of the previous methods.

Such previous methods or aspects of such methods are described for example in Taylor, W. R. et al., “On the influence of soft tissue coverage in the determination of bone kinematics using skin markers”, J. of Orthopaedic Research, (2005), Ehrig, R. M., et al. “A survey of formal methods for determining the center of rotation of ball joints”, J. of Biomechanics (2006), Ehrig, R. M., et al. “A survey of formal methods for determining functional joint axes”, J. of Biomechanics (2007).

Overall hitherto all methods which relate to detecting items of information which are relevant to the characterization of joint movements (for example skin marker displacements, skin elasticity, joint parameters such as body joint centers or axes) are excessively prone to error, inaccurate and thus unreliable. To compensate for that disadvantage generally time-consuming and complicated manual analysis procedures have to be carried out.

### DISCLOSURE OF INVENTION

The aim of the invention, besides detecting or determining with the greatest possible accuracy items of information which are relevant to the characterization of joint movements (for example skin marker displacements, skin elasticity, joint parameters such as body joint centers or axes), is also ascertaining evidence about the reliability of the items of information which are detected or determined.

According to the invention that aim is achieved by a method of the kind set forth in the opening part of this specification, in the context of the implementation of which markers are fitted to the skin at both sides of a body joint, and which comprises the following method steps:
determining a mean marker configuration and determining time-dependent discrepancies from the mean configuration, wherein an orthogonal distance regression (ODR) is carried out for determining a mean marker configuration and wherein markers fitted on a respective side of the body joint are used;
carrying out a weighted ODR using the time-dependent discrepancies from the mean configuration for weighting, wherein markers fitted on a respective side of the body joint are used; and
solving a linear equalization problem using items of information which were determined by carrying out the weighted ODR.

In addition the aim is achieved by means of an apparatus for evaluation of the joint function of an experimentee and/or by means of an apparatus for the evaluation of musculoskeletal loadings of an experimentee, wherein the apparatuses are respectively provided with suitable means for carrying out the above-outlined method, wherein the apparatuses can have respective different means for carrying out various method steps of the above-outlined method and wherein said means can be implemented in various combinations.

The above-specified aim is achieved by means of a movement analysis system, in particular a gait analysis system, wherein the movement analysis system is coupled to the above-specified apparatus for evaluation of the joint function of an experimentee.

The aim is also achieved by means of a navigation system for computer-aided surgery, wherein the navigation system is provided with suitable means for carrying out the above-outlined method, wherein the navigation system can have various means for carrying out various method steps of the above-outlined method and wherein said means can be implemented in various combinations.

In addition the above-specified aim is achieved by means of a medical imaging method, in particular by means of a magnetic resonance-based method, wherein the medical imaging method is coupled to at least one of the above-specified apparatuses—apparatus for evaluation of the joint function of an experimentee, and apparatus for the evaluation of musculoskeletal loadings of an experimentee.

As is partially indicated in the presentation of the background of the invention, the above-specified steps are carried out after fixing of skin markers on parts of the skin on both sides of a body joint and after recording the marker trajectories during a joint movement of the body joint by means of an optical, infrared or other suitable system. FIG. 1a shows by way of example skin markers applied to the skin of a leg of an experimentee. FIG. 1b shows by way of example the joint centers and axes for hip, knee and ankle joint, which are derived after recording of skin markers and the corresponding skin marker trajectories.

One of the first steps for the analysis of joint movements from marker data involves carrying out an ODR, by means of which a mean marker configuration of markers respectively fitted on sides of the body joint is determined. In that case, in the first step, time-dependent corrections of individual markers, that is to say time-dependent discrepancies from the mean configuration, are also calculated. The ODR performed in that step can be a conventional ODR, for example like the ODR represented in Taylor, W. R. et al., “On the influence of soft tissue coverage in the determination of bone kinematics using skin markers”, J. of Orthopaedic Research, (2005).

In addition the time-dependent corrections, which have already been determined, of individual markers, or the time-dependent discrepancies from the mean configuration are used to perform a weighted ODR. In that case the skin markers which are moving most greatly relative to the other skin markers are detected, and the skin markers are weighted in accordance with their relative movement in such a way that skin markers which are moved relatively to a greater degree are weighted less. That determines an optimum marker configuration, to which all of the markers belonging to the configuration contribute in accordance with their stability within the experimental configuration. That permits robust automatic pre-processing of the marker data and takes account of the different time-dependent stability of individual markers. In addition, that permits quantification of the skin marker displacements of individual markers and thus makes it possible to describe the elasticity of the soft parts.

In a further step, a linear equalization problem is solved using items of information which were determined by carrying out the weighted ODR. Those items of information are the marker data corrected with the ODR or the optimum marker configuration. The step of determining the linear equalization problem is effected using transformation matrices. Those transformation matrices can be calculated for each measurement time and each side of the body joint.

As the sides of the joint are taken into consideration when carrying out both the conventional ODR and also the weighted ODR and/or when solving the linear equalization problem, the movement of two articulating joint bodies is described.

Parameters for a description of joint movement (joint parameters) are determined by a joint center, joint axes and/or the primary joint axis, by means of the solution to the equalization problem. That method is completely symmetrical in regard to the joint segments involved and also affords the advantage that no transformation procedures, which are prone to error, into local (coordinate) systems of the segments are required.

Solving the linear equalization problem itself can be carried out using a singular value analysis process. By virtue of the use of all singular values and the associated singular vectors, the method affords an analysis of the primary and secondary components of the joint movement. In that case joint movements are broken down into rotations about three (rotational) main axes and the singular values are associated with the main axes. In that case the singular values associated with the main axes afford weightings for all components of a joint movement, which in that way can be automatically classified and assessed. In that way the type of joint (for example ball joint, hinge joint) can be uniquely derived from experimental data. In addition the concept of breaking down any joint movement into rotations about three rotational main axes allows quantification of a joint movement not only in relation to the main axis, which is the rule in existing methods, but in relation to all three main axes.

The accuracy of the joint parameters determined can be directly ascertained from the remainder of the linear equalization problem and thus automatically quantified. That permits a direct representation of the quality of measurement without further manual analysis procedures being required. That ensures comparability of the measurement results in the case of longitudinal studies on the same experimentee or permits routine optimization of the placement of markers in relation to different experimentees. In addition, when taking account of corrections which are effected by the ODR, that affords automatic separation of the marker movements into collective movements and into movements of individual markers.

The notion of directly ascertaining the accuracy of the joint parameters determined from the remainders of the linear equalization problem and automatically quantifying same represents an independent concept of the invention which can also be implemented independently of the other method steps and in particular also independently of the performance of a weighted ODR.

A method which is independently inventive of detecting information relevant to the characterization of joint movements includes for example the following method steps:
predetermining or ascertaining at least two matrices which describe marker points prior to and after a joint movement,
determining a transformation matrix for the two matrices by solving a linear equalization problem, and
evaluating the remainders of the solution to the linear equalization problem and determining a quality index for the implemented method from the remainders.

In addition the primary axis and at least one secondary axis of a movement of the joint can be determined from that movement. In that respect the stability of the primary axis of the movement of the joint can be ascertained by means of items of information in relation to the at least one secondary axis of the movement.

In addition it is possible, if movements are performed repeatedly and the secondary axes and the stability of the primary axes are correspondingly repeatedly ascertained, to determine from the items of information obtained in that way a cycle which provides a characterization of the function of the corresponding joint (joint function).

In addition a scope of the individual dynamic joint stability and/or scope of movement of the joint can be ascertained by items of information in relation to secondary axes of a plurality of movements.

In addition the above-indicated aim is achieved by means of a method of determining joint stiffness, wherein by that method steps in accordance with the above-outlined method are carried out, wherein the steps can be carried out in any meaningful combination apparent to a man skilled in the art and wherein the joint stiffness is determined using items of information in relation to forces of joint movements. The information in relation to external forces in the case of joint movements can be ascertained using a robot or using a robot assistance system. In that case joint movements are performed by a robot which is linked in the robot assistance system and are detected by the robot assistance system together with the forces and moments required for performing the movement. The items of information obtained in that way contain information in relation to forces for performing the joint movements, by means of which joint stiffness (stiffness of the corresponding joint) can be ascertained, overall or for specific directions.

The above-indicated aim is further also achieved by means of a system of detecting information relevant to the characterization of joint movements, wherein the system has at least one means which is adapted for carrying out the method of determining joint stiffness and which is coupled to the robot assistance system for detecting, analyzing and/or determining items of information which are relevant to joint movements.

In addition the above-indicated aim is achieved by a method of detecting information relevant to the characterization and/or evaluation of ortheses, wherein by the method steps in accordance with the above-outlined method of detecting information relevant to the characterization of joint movements are carried out and wherein the information relevant to the characterization of joint movements is linked to information in relation to ortheses and analyzed. By means of that method, it is possible to provide statements about various features such as for example the effectiveness of the corresponding ortheses. In that respect the knowledge about the corresponding joints or joint movements, which is ascertained inter alia by the above-specified methods according to the invention, can be linked or related to the knowledge about the corresponding ortheses, in a suitable fashion, and appropriately analyzed, and thus comprehensive characterization and/or evaluation of ortheses is achieved.

The present invention thus permits a robust analysis of the joint movements with simultaneous automatic quantification of accuracy. In addition it provides for an analysis of the errors caused by marker movements and classification of the joint movement in relation to orthogonal rotational main axes. The present invention further affords various options for ascertaining or determining information relevant to the characterization of joint movements, whereby various aspects can be afforded in relation to the functionality of a joint.

As already mentioned the invention makes it possible to ascertain information relating generally to movements of bone fragments or parts which are in mobile relationship with each other such as for example bone fragments of a fracture or bone breakage. The term joint is thus of a broad significance. The terms joint movement, movement, movement of a joint are thus also to be viewed as movements of such bone fragments which as in the case of bone breakages or fractures are in mobile relationship with each other and have a kind of abstract joint movement when motion occurs. The term joint is used not only to denote a specific joint such as for example a knee joint or a hip joint, it can also be a kind of abstract joint about which a movement of bones or bone fragments or pieces takes place.

### BRIEF DESCRIPTION OF THE DRAWINGS

The invention is described in detail hereinafter by way of example with reference to the accompanying Figures in which:

FIG. 1a shows markers fixed on skin,

FIG. 1b shows a typical marker configuration, with derived joint centers and axes for hip, knee and ankle joints,

FIG. 2 shows a block diagram representing the procedure for detecting the movement of a joint from marker trajectories,

FIG. 3 shows a block diagram representing the steps of determining and evaluating joint parameters,

FIG. 4 shows the definition of local coordinates for two positions of a segment,

FIG. 5 shows the center and the main axis of the knee movement and two secondary axes (tibia and femur),

FIG. 6a shows a comparison of the position of the mean flexion axis for a first defined flexion angle range in the case of 7 experimentees with rupture of the anterior cruciate ligament in comparison with the position of the axis in the case of healthy experimentees as a side view,

FIG. 6b shows a second comparison of the position of the mean flexion axis for a further defined flexion angle range in the case of 7 experimentees with rupture of the anterior cruciate ligament (pink) in comparison with the position of the axis in the case of healthy experimentees in a view from the front, and

FIG. 6c shows a third comparison of the position of the mean flexion axis for a first defined flexion angle range in the case of 7 experimentees with rupture of the anterior cruciate ligament (pink) in comparison with the position of the axis in the case of healthy experimentees in a view from the front.

### DETAILED DESCRIPTION

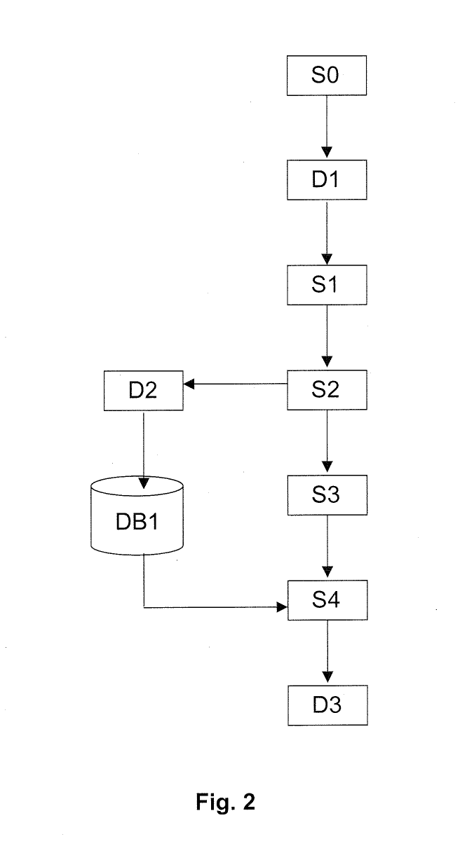

The block diagram shown in FIG. 2 illustrates an embodiment by way of example for detecting the movement of a joint from marker trajectories.

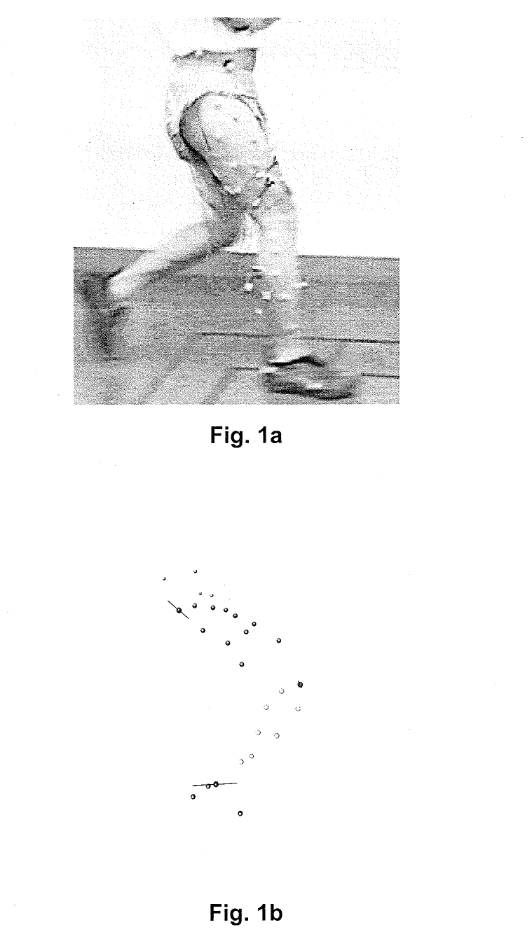

In step S0 markers are fitted or fixed to the skin. FIG. 1a shows an example of such markers fixed to the skin of a leg of an experimentee. Then marker trajectories are measured upon a movement on the part of the experimentee. The result of S0 are time-dependent spatial positions of all markers. For carrying out step S0, any standard methods in biomechanics which are intended for that purpose can be used. If reflecting skin markers are used the marker trajectory data can be recorded by means of an optical, infra red or other suitable system during a joint movement of a body joint.

The result data (information in relation to marker trajectories or time-dependent positions of all markers) and a possible amount of additional information relevant to further calculation and analysis represent input data D1 for the further step S1. At this point, a user interface can be employed to record or read in data D1. A graphic 3D visualization of the data D1 can also be presented. The various possible ways of processing data will be apparent to a man skilled in the art from the usual practice.

Step S1 involves performing a conventional ODR, wherein that marker configuration which best describes the measured configurations for all moments in time is ascertained by the ODR for each body segment. That is effected by minimization of the functional

Σ_{i<j}ⁿ|RᵢAᵢ+tᵢ−(RⱼAⱼ+tⱼ)|.

Therein Rᵢ, tᵢ are the rotations and translations to be ascertained for the marker set Ai, and n is the number of observations. In mathematics that is what is referred to as a “Generalized Procrustes Analysis” which is solved with an orthogonal distance regression. That provides an optimum mean configuration:

Aₚ=Σ(RᵢAᵢ+tᵢ)/n

and minimally altered time-dependent configurations:

Aᵢ^{P}=Rᵢ^{T}Aₚ−tᵢ

with identical geometries. The ODR thus corrects the discrepancies of individual markers from the optimum mean configuration. Such a method is described for example in the above-noted publication by Taylor et al. 2005.

In a further step S2 a calculation of time-dependent discrepancies of the configuration is carried out based on raw data in relation to the optimum mean configuration. The following applies for that calculation: the less the position of a marker fluctuates within the configuration, the correspondingly less are the corrections effected at the experimentally measured marker positions by the ODR. These are therefore a direct measurement for the stability of the markers. They can thus be used to ascertain marker configurations which are as stable as possible, that is to say to optimize the placement of markers. Those marker placements can be considered as being optimal, for which for example on the one hand small corrections are afforded by the ODR and those corrections are also as equal as possible for all markers. In addition routine detection of erroneous measurements (for example marker transpositions) is possible as that can be recognized by virtue of very much greater corrections and excluded. In addition they make it possible to build up a database DB1 which collects the relationship of such discrepancies in respect of age, sex, BMI, illnesses, measurement methods and measurement location and permits an analysis of such relationships. For that purpose the result data D2 of S2, which are relevant to the database DB1, are received in the database DB1 and possibly stored there.

Information relevant to the characterization of joint movements such as muscle activity and/or local elasticity of the soft parts can be ascertained from the steps S1 and S2.

In step S3 a second ODR—a weighted ODR using the ascertained discrepancies—is carried out. The correction factors determined by the step S2 can be used to ascertain weighting factors which are used for carrying out the second weighted ODR. The weighting factors are afforded for example from the inverse of the correction terms of the ODR. The weighting operation can be carried out on the one hand in time-independent fashion by using an averaged correction term for each marker. A time-dependent application is achieved by using the currently prevailing correction of the ODR for the weighting process, for each moment in time. In both cases all markers contribute to determining the optimum mean configuration, in accordance with their experimental stability. When using time-dependent weighting the weighting of a marker can also be heavily dependent on the relative position of the segments with respect to each other, that is to say for example a flexion angle. Step S3 involves ascertaining an optimum marker configuration, to which all markers contribute in accordance with their stability within the experimental configuration.

Step S4 provides for carrying out evaluation of the optimum configuration. In that case the results are evaluated in accordance with S2. In particular significant differences between the results from steps S1 and S3 are analyzed—robust marker placements are distinguished for example by slight differences between the simple and the weighted ODRs.

The steps S1-S3 and/or S4 permit robust automatic pre-processing of the marker data. Time-consuming manual correction processes which are governed by differing time-dependent stability can thus be avoided. Furthermore quantification of the skin marker displacements of individual markers and thus detection of the elasticity of the soft parts becomes possible.

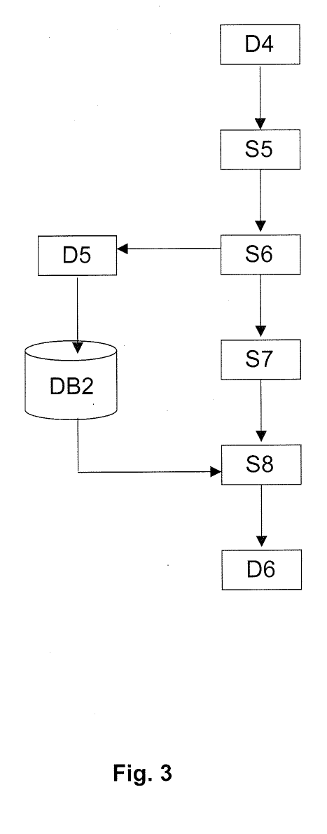

The block diagram in FIG. 3 shows an embodiment with steps of determining and evaluating joint parameters, in particular positions of a joint center and joint axes, wherein those positions can also be time-dependent. In addition it is also possible to ascertain secondary movement components.

The data obtained from evaluation of the optimum configuration and/or the result data of steps S1-S3 can serve as input data D3 for ascertaining joint parameters and the evaluation thereof. As the steps S1-S4 are based on the use of skin markers, it is to be noted here that the steps of determining and evaluating joint parameters, shown by way of example in FIG. 3, do not necessarily presuppose information in relation to markers placed on skin. Here for example it is also possible to consider markers fixed on bones (for example pins in bones). The step of ascertaining joint parameters and the step of evaluating same have a place both in invasive and also in non-invasive methods. Invasive methods like pins in bones are used for example for an intra-operative application in the context of computer-aided navigation in relation to orthopedic/traumatological interventions (replacement/reconstruction of cruciate ligaments, correction osteotomies, endoprosthetic joint replacement). Here the use of various markers becomes a possibility—optically reflecting markers which are fixed on the skin, electromagnetic markers which can then also be fixed on the skin or in/on the bone. It is also possible to conceive the method of calculating a joint center or an axis together with tantalum markers which are used for so-called RSA investigations (in that case small tantalum markers are introduced into the bone (intra-operatively) or to/in prostheses (components) and then the 3D position of the markers is reconstructed with an X-ray method. In addition it is also conceivable that surfaces or contours of bones/joints are ascertained for example from a possibly dynamic nuclear spin tomography. As a result “point clouds” (collections of points) are then available, with which the joint centers and/or axes can be ascertained.

In consideration of those facts it must be stated in advance that the implementation of the method steps in accordance with the embodiment of FIG. 3 does not necessarily presuppose the implementation of steps in FIG. 2, in particular steps S1-S3. That will be apparent to a man skilled in the art from the description hereinafter. Accordingly, besides D3, generally data in relation to markers or “point clouds” and/or the configurations thereof can serve as input data D4.

The embodiment is however shown by way of example based on the steps in FIG. 2.

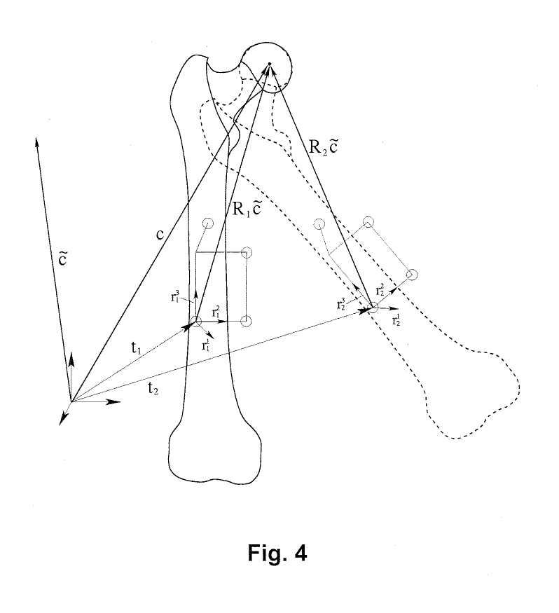

The marker positions ascertained by means of the double ODR are now used to calculate the joint parameters. These are the (possibly also time-dependent) positions of joint center and joint axes as well as the detection of secondary movement components. For that purpose, local coordinate systems are defined in the associated body segments by means of three respective markers and the rotations Rᵢ and translations tᵢ (body segment 1), and Sᵢ and dᵢ (body segment 2) are calculated from global coordinates into those local systems, see FIG. 4. The conditions for a joint center or a joint axis afford the following n equations which together define an over-determined linear equation system, that is to say a linear equalization problem:

Rᵢc₁−Sᵢc₂=dᵢ−tᵢ

Therein c₁ and c₂ are the coordinates of the joint center in the respective local systems, and n is the number of measurements. That approach is distinguished in that it is completely symmetrical in regard to both segments and does not require any previous transformation. The corrections effected by means of the ODR provide that the marker configurations are identical for all moments in time and the results are therefore completely independent of the choice of the three markers for the construction of local coordinates.

With an enlarged approach, determination of the axes of rotation is also possible in the situation where those axes do not have a point of intersection. That then not only permits precise determination of the direction of the axes, but also the position thereof. That affords important new unique criteria for differentiating various patterns of joint movements in the context of diagnostics, for example by the comparison of a typical movement pattern of a healthy knee and a knee suffering from cruciate ligament damage. Uniquely determining the position of the axes also makes it possible to monitor and ensure the success of a surgical intervention (for example cruciate ligament reconstruction, correction osteotomy near the knee joint, endoprosthetic joint replacement) in pre-post-operative comparison.

To ascertain the position of axes of rotation which do not have a common point of intersection the method according to the invention of solving a specific linear equalization problem is used. It supplies the direction vectors u₁, v₁, w₁ (segment 1) and u₂, v₂, w₂ (segment 2) of the three axes of rotation. The rotational matrices Rᵢ and Sᵢ are now broken down into elementary rotations for both segments, for n measurements.

Rᵢ=Rᵢ^{u1}Rᵢ^{v1}Rᵢ^{w1}, Sᵢ=Sᵢ^{u2}Sᵢ^{v2}Sᵢ^{w2}

In that case for example Rᵢ^{u1} is the rotational component of Rᵢ about the axis u₁. Using the rotations obtained in that way, by solving a further linear equalization problem which is given by the n equations:

((Rᵢ−Rᵢ^{u1}Rᵢ^{v1})c_{w1}+(Rᵢ^{u1}Rᵢ^{v1}−Rᵢ^{u1})cᵥ₁+Rᵢ^{u1}cᵤ₁)−((Sᵢ−Sᵢ^{u2}Sᵢ^{v2})c_{w2}(Sᵢ^{u2}Sᵢ^{v2}−Sᵢ^{u2})cᵥ₂+Sᵢ^{u2}cᵤ₂(dᵢ−tᵢ)

it is also possible to ascertain points cᵤ₁, cᵥ₁, c_{w1} (segment 1) and cᵤ₂, cᵥ₂, c_{w2} (segment 2) on the axes of rotation. Therefore, together with the directional vectors which are already known, the axes are uniquely determined. The solution to that equalization problem can also advantageously be effected with a singular value decomposition (SVD).

The solution to the equalization problem is calculated in step S5 by means of a singular value decomposition (SVD) of the matrix of the linear equalization problem. That supplies for each body segment a local description of the joint center (c1, c2). If the joint moves like an ideal hinge joint, no clear solution to the equalization problem exists. In other words, the one-dimensional solution space which associated with the singular value is with the value zero then represents the joint axis in local coordinates. In the practical case the behavior of the joint is exactly described by the relationship of the smallest singular value relative to the others, that is to say that entails a simple classification of the joint between ball and hinge joints. The description of center or axis, contained in the segment coordinates, can finally be transformed into time-dependent global coordinates.

As the equalization problem generally cannot be exactly solved, there is a remainder r which reflects the accuracy of measurement. In step S6 analysis of the remainder r of the equalization problem is carried out.

A mathematical analysis of the remainder shows that it is in a direct relationship with the extent of the marker movements. If for example only collective marker movements in both segments are assumed, that gives:

|r|²=(6n−12)σ²

For pure individual marker movements, that gives the following:

|r|²=0.5(n−2)σ²(|c₁|²+|c₂|²|)

in which σ is the mean discrepancy of the markers from the optimum position. For the error d in the position of a joint center, under the same conditions, that gives the estimate:

|δ|²=12σ²/σ₆²

wherein σ6 is the smallest singular value of the SVD.

For individual marker movements once again the following applies:

|δ|²=σ²(|c₁|²+|c₂|²|)/(2σ₆²)

Those relationships can be effectively used to determine the actual accuracy of the joint parameters ascertained. In combination with the experimentally ascertained discrepancies from the mean configuration, it is thus possible to quantitatively describe collective movements of the markers and movements of individual markers. That makes it possible to specifically optimize the placement of the markers in relation to experimentees.

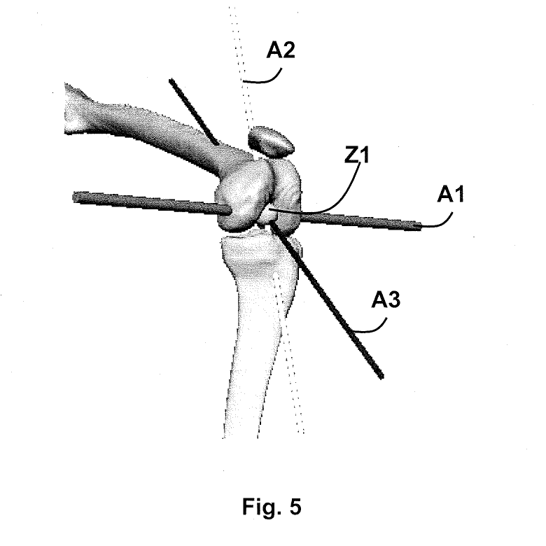

Step S7 involves decomposition of any joint movement into rotations about three main axes of rotation. The SVD analysis of the equalization problem thus permits more extensive analysis of the actual joint movements. The singular vectors associated with the individual singular values can be interpreted as axes of primary and secondary movement components and provide for decomposition of the movement into three main axes of rotation. FIG. 5 shows a joint center and three joint axes on the example of a knee. The joint center is denoted by Z1, the main axis of the knee movement by A1 and two secondary axes by A2 and A3, wherein A2 refers to the tibia and A3 to the femur. The smaller the respective associated singular value the greater is the proportion of the associated rotation (see FIG. 5). That permits routine detection of movement components such as internal rotation and abduction/adduction for the knee joint without additional measurements being required. While those movement components in a stable joint are small, injuries to the internal structures of the joint (for example due to a tear in the anterior cruciate ligament) or degenerative diseases of the joint (gonarthrosis) can involve a loss of joint stability which is reflected in increased amounts of internal/external rotation or abduction/adduction and which can be quantified with the new approach. In a similar way the influence of interventions on the stabilizing elements (ligaments/bones) in the context of a correction osteotomy or artificial joint replacement (resection/construction of the bone, manipulation on soft parts (ligaments)) on the function of the joint can be accurately and reliably ascertained. In order to make that information also intra-operatively useable for the operator, linking of the method to a navigation system is advantageous. In that case for example the joint axes in relation to the individual bony anatomy and for example the position of ligament attachment points can be displayed during various phases of the operation in order to allow the operator a more accurate estimate of the success of the surgical intervention in respect of the joint function for example by a comparison with the position of the axis in the healthy person or an axis ascertained as optimum in another fashion.

The relationship between the amount of a rotation and the associated singular value can be further mathematically specified. For the three smallest singular values which are associated with the axes of rotation it is possible to derive the following relationship:

σ₄²=n(1−r₂r₃/n²),σ₅²=n(1−r₁r₃/n²),σ₆²=n(1−r₁r₂/n²)

Therein the values r₁, r₂, r₃ are directly interpretable values by the relationship with the measure known from statistics for angular dispersion (1−rᵢ/n) of the rotations about the axes i=1, 2, 3. Thus it is possible to derive from the singular values, values for the angle ranges Φᵢ which include the rotations about the three axes of rotation. If a continuous distribution of the measurements in that range is assumed to apply, that assumption is generally well met, that gives this relationship a:

rᵢ/n=sin(Φᵢ)/Φᵢ

That relationship makes it possible to also immediately quantify for the secondary movement components in a very good approximation the angle range within which they occur. Therefore, it is not only information in relation to the position and orientation of the main axes of the movement that is available, for assessment of the joint function, but also a further quantitative measure to characterize the respective joint condition and to detect deviations from the norm quickly and also to already detect minor deviations reliably.

The results of S6, which characterize the remainders, can be deposited or stored in a database or some other data container D2. D2 then contains data relating to remainders in dependence on various factors such as age, sex, BMI, illness, extent of the illness, measurement location, type of joint and so forth.

In step S8 evaluation of the joint configuration, of the data relevant to the joint movement, can be carried out. In that case the results of step S6 and/or step S7 can be compared to the results of S4, in which case data from D2 can also be used for determining the evaluation.

The data ascertained by the method, information from D1 and/or from D2 and/or further items of information, can be outputted as desired in the form of data D6 in various combinations and detail planes and possibly graphically (3D) displayed.

To represent the results the axes can be displayed by means of a color scale (for example blue . . . red), which links the singular values of the axes to a corresponding color. In addition the diameters of the axes can also be varied in accordance with the associated singular values, and displayed. The above-mentioned display variants can also be combined and thus also permit utilization and display of the conditions for the overall movement or specific regions of the movement. That permits the user to rapidly acquire the results.

In addition both the steps which perform the ODR and also the formulation of the equalization problem can be so implemented that fresh data can be added, at a very low level of computing complication and expenditure. In that way it is possible to permit real time measurements in which joint parameters and also data relating to accuracy are already available during the movement.

In addition it is to be noted that implementation of the steps S1 and S3 which are related to ODR make it possible to ascertain the (skin) marker-related data with sufficient accuracy that good primary joint axes can be determined even for small movements (ROM, range of motion). The secondary axes, together with the associated singular values, are then a sensitive criterion for distinguishing between normal or conspicuous movement behavior.

In addition the present invention can be used to quantify the function of a joint, for example the knee joint, at various hierarchical stages (global: joint, specific: structures), possibly by means of specific feedback mechanisms, for interaction with the user of the method.

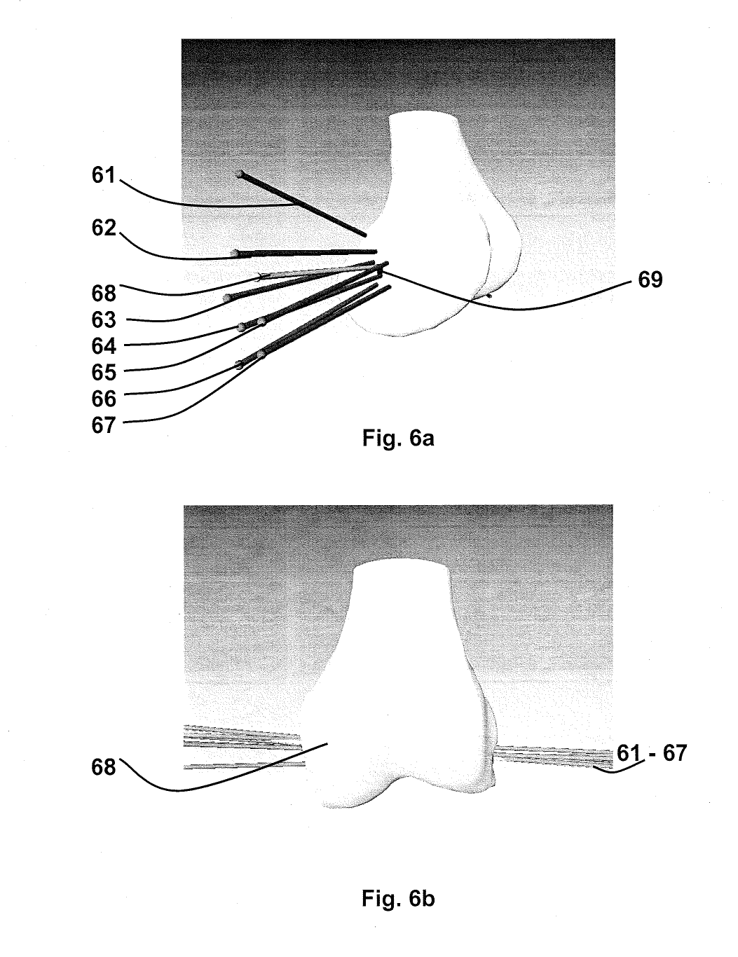

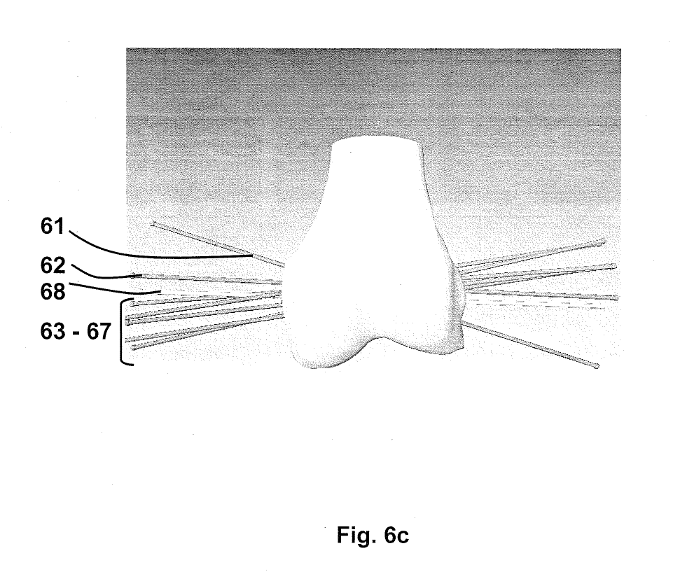

It is known that the flexion/extension axis is the main axis of movement of the knee joint. Therefore, in the method of characterizing the function of the joint, firstly the knee is bent, and the main and secondary axes of the movement are calculated from the flexion or flexion/extension movement, with the method according to the invention. Calculation is effected in respect of axes which are averaged both over the entire extent of movement and also over specific sub-ranges of the extent of movement, for example in dependence on flexion angle. For deciding which regions can be used for determining the axes, knowledge about the existing pathology can also be involved (for example bend angle-dependent significance of the anterior cruciate ligament, for the stability of the joint in respect of rotation/translation). The secondary axes which are ascertained in accordance with the invention in that case (magnitude of the associated singular values, position of the secondary axes, for example in the medio-lateral, anterior-posterior, superior-inferior directions, in comparison with the position of the primary axis, in that case provide direct quantitative information in respect of the stability of the primary axis and therewith the joint. As additional information for evaluation and representation of the results, it is also possible to use the position of the axes in relation to the individual anatomy (for example transepicondylar axis, axis of the posterior condyles, position of the ligament insertions, for example of the lateral ligaments), also in comparison with the situation in the healthy person. To quantify the difference in the position of the axes, it is possible to ascertain a joint center, and it is thus possible to establish a significant point on the axis. It is thereupon possible to ascertain differences in the position of the various axes. A possible way of calculating the differences in the position of the various axes in that fashion is set forth for example in Ehrig et al., “A survey of formal methods for determining functional joint axes” Journal of Biomechanics 2007; 40: 2150-57. An evaluation of the position of the primary axis in relation to the anatomy is shown in FIGS. 6a and 6b. FIGS. 6a, 6b and 6c each show a comparison of the position of the mean flexural axis 61-67 for a defined flexion angle range in the case of seven experimentees with rupture of the anterior cruciate ligament in comparison with the position of the axis 68 in the case of healthy experimentees. In FIG. 6a, the standard deviation of the position of the axis in the healthy person is additionally specified by the oval 69 and by the length of the semi-axes correlated with standard deviation. In FIG. 6b the anterior cruciate ligament contributes only little to knee stability so that the axes for the patients differ only little from the axis of a healthy person. In FIG. 6c once again the anterior cruciate ligament contributes markedly to joint stability so that the axes for the patients deviate considerably from the axis of a healthy person.

The information relating to the secondary axes can also be used to provide the user directly with feedback as to whether on the one hand the measurement corresponded to the accuracy requirements or whether recording of the movement/function possibly has to be repeated to reliably characterize the function of the joint. For that purpose the user can be given feedback as to how the movement is best carried out, in that for example the singular values associated with the secondary values are represented and the user can optimize same. Evaluation of the magnitude of the singular values of the secondary axes of a plurality of movement cycles also makes it possible to automatically determine that cycle which is best suited to characterizing the joint function.

To be able to analyze the joint function with even greater accuracy, further movements can be carried out so that secondary degrees of freedom of movement of the knee joint are at the maximum and minimum respectively of the possible range of motion. Thus for example the joint is rotated inwardly or outwardly as far as possible for a cycle or abducted or adducted as far as possible and/or displaced as far as possible anteriorly or posteriorly, or medially or laterally. The secondary axes ascertained in accordance with the invention in respect of the movement (position of the axes and magnitude of the associated singular values) are calculated and specified and thus permit direct control and determination of the extent to which secondary degrees of freedom were actually eliminated. Overall the space of the individual dynamic joint stability is described by the totality of the axes from the analysis of the various movements. Thus the present invention permits comprehensive characterization of the individual joint function over the entire range of motion which can be used when performing everyday activities or also during sporting activities.

The stabilizing action of the structures of the knee joint (for example ligaments, bones, cartilage, muscles) is dependent on the knee joint position. Therefore detailed information relating to the function of various structures can be acquired by specifically targeted analysis of the configuration of the joint axes for specific joint positions. For that purpose the joint is deliberately exposed in various bend angles which as far as possible remain the same, by the user, to such external loadings which primarily result in movements of the joint in relation to the secondary axes of the knee joint (abduction/adduction, internal/external rotation). Thus, the user, for a given bend angle, induces an inward or outward rotation, which is of the maximum possible extent, of the joint, or abduction/adduction of the joint. To check to what extent that movement was actually induced by the user, calculation according to the invention is effected in respect of all axes (position of the axes and/or magnitude of the singular values associated with the axes) for those specific movements. Then, by means of the axis determination method according to the invention, it is possible to calculate the range of motion (in each case maximum minus minimum), in relation to those degrees of freedom. The extents of movement and the respectively greatest and smallest displacements are related to data of for example healthy experimentees (possibly age- and/or sex-specifically adjusted and represented), and evaluated.

In addition the position of the axes in relation to the previously ascertained main axis of movement and/or the joint center, possibly also of the anatomy (such as for example bones, ligament insertions, anatomical axes of the knee joint) is ascertained. In comparison with the relative positional relationship of the axes or magnitude of the singular values associated with the axes for healthy experimentees, it is thus possible to accurately quantify the deviation of a pathological knee condition. That is effected for example by calculation of the difference in the medio-lateral, anterior-posterior or superior-inferior position of the axis in the case of internal/external rotation or abduction/adduction of the experimentee in comparison with the healthy person. Thus the method according to the invention additionally implements accurate quantitative characterization of the function and the interaction of selected structures of the joint.

A further area of application of the present invention is for example the calculation and representation of functional joint axes by integration of the method according to the invention into apparatuses for medical imaging such as for example magnetic resonance tomographs. By virtue of the link to medical imaging those apparatuses can be used to dynamically display musculoskeletal function and also to evaluate same, in the sense of “musculoskeletal functional imaging”.

In addition the present invention permits linking of anatomy to function for the detailed calculation of musculoskeletal loadings. That link can also be of significance for the motion capture/film industry for the more realistic representation and animation of movements.

Although the invention is described hereinbefore in relation to the embodiments as shown in the accompanying drawings it is apparent that the invention is not restricted thereto but can be modified within the range of the inventive idea disclosed hereinbefore and in the accompanying claims. It will be self-apparent that there can also be further embodiments which represent the principle of the invention and are equivalent and that thus various modifications can be implemented without departing from the scope of the invention. In particular this concerns the choice of the markers, which also permits independent implementation of the steps S5-S8, the configuration of the data containers D1 and D2 and the evaluation steps S4 and S8 which can be appropriately modified depending on the respective interests of the user. In addition various configurations are possible in respect of the above-specified apparatuses, systems and imaging methods, these will be apparent to the man skilled in the art from the foregoing description of the present invention and from the content of the claims. The present invention affords a large number of areas of use (for example the above-described evaluation of ortheses) which will also be apparent to a man skilled in the art. In particular the broad definition of the terms joint or joint movement allows a large number of areas of use.

1. A method of detecting information relevant to the characterization of joint movements, wherein markers fitted to the skin on both sides of a body joint are used for the analysis of joint movements and wherein the method includes:
determining a mean marker configuration and determining time-dependent discrepancies from the mean configuration, wherein an orthogonal distance regression is carried out for determining a mean marker configuration and wherein markers fitted on a respective side of the body joint are used;
carrying out a weighted orthogonal distance regression using the time-dependent discrepancies from the mean configuration for weighting, wherein markers fitted on a respective side of the body joint are used; and
solving a linear equalization problem using items of information which were determined by carrying out the weighted orthogonal distance regression.

2. The method as set forth in claim 1 wherein an optimum marker configuration is determined with the implementation of the weighted orthogonal distance regression.

3. The method as set forth in claim 1 wherein the linear equalization problem is determined using transformation matrices.

4. The method as set forth in claim 3 wherein the transformation matrices are calculated for each measurement time and each side of the body joint.

5. The method as set forth in claim 1 wherein the solution to the equalization problem determines parameters for a description of a joint movement by a joint center and/or joint axes.

6. The method as set forth in claim 5 wherein stability of a primary axis is ascertained by means of items of information in relation to the at least one secondary axis of the joint movement.

7. The method as set forth in claim 6 wherein after at least one repeated implementation of the operation of determining at least one secondary axis and the step of ascertaining the stability of the primary axis, a cycle is determined, which provides a characterization of a joint function.

8. The method as set forth in claim 6 wherein a space in respect of the individual dynamic joint stability and/or extent of movement of the joint is ascertained by secondary axes of a plurality of joint movements.

9. The method as set forth in claim 1 wherein the solution to the linear equalization problem is implemented by a singular value analysis.

10. The method as set forth in claim 9 wherein the method includes carrying out a singular value decomposition and description of the joint movement by main axes of rotation using singular values and singular vectors.

11. The method as set forth in claim 10 wherein joint movements are decomposed into rotations about three main axes and wherein the singular values are associated with the main axes.

12. The method as set forth in claim 10 wherein the singular values determine weightings for all components of a joint movement.

13. The method as set forth in claim 5 wherein the accuracy of the joint parameters which are determined is directly ascertained from the remainders of the linear equalization problem.

14. Apparatus for evaluation of a joint function of an experimentee with means adapted to carry out the method as set forth in claim 1.

15. A movement analysis system, in particular a gait analysis system, characterized in that it is coupled to an apparatus as set forth in claim 14.

16. Apparatus for evaluation of musculoskeletal loadings of an experimentee with means adapted to carry out the method as set forth in claim 1.

17. A navigation system for computer-aided surgery, wherein the navigation system is adapted to carry out a method as set forth in claim 1.

18. A medical imaging method, in particular a magnetic resonance-based method, which couples medical imaging methods to an apparatus as set forth in claim 14.

19. A medical imaging method, in particular a magnetic resonance-based method, which couples medical imaging methods to an apparatus as set forth in claim 16.

20. A method of determining joint stiffness, wherein by means of the method steps in accordance with the method as set forth in claim 1 are carried out and wherein the joint stiffness is determined using items of information in relation to forces during joint movements, wherein the items of information in relation to forces of joint movements are ascertained using a robot.

21. A system for ascertaining information relevant to the characterization of joint movements, wherein the system has at least one means which is adapted to carry out the method as set forth in claim 20 and which is coupled to a robot assistance system for analyzing and/or determining information relevant to the joint movements.

22. A method of ascertaining information relevant to the characterization and/or evaluation of ortheses, wherein by means of the method steps in accordance with the method as set forth in claim 1 are carried out and wherein the information relevant to characterization of joint movements is linked to information in relation to ortheses and analyzed.
